(19) United States
(12) Patent Application Publication
(10) Pub. No.: US 2011/0276876 A1
(43) Pub. Date: Nov. 10, 2011

(54) Method and system for storing words and their context to a database

(76) Inventors: Chi Shing Kwan, Foster City, CA (US); Chun Yu Tsui, Foster City, CA (US)

(21) Appl. No.: 13/094,822

(22) Filed: Apr. 27, 2011

Related U.S. Application Data
(60) Provisional application No. 61/331,393, filed on May 5, 2010.

(51) Int. Cl. G06F 17/27

(52) U.S. Cl. 715/256

(57) ABSTRACT

A method and system for conveniently storing words and their context to a database. This system and method is called Wordbees. A user uses Wordbees to store a selected word in an electronic document by running Wordbees extraction tool while the selection is in place. Wordbees detects the selected word and extracts the context of the word. Further Wordbees stores the word and its context in a database. Wordbees further provides an interface for the users to review the words they stored.

### CROSS-REFERENCE TO RELATED APPLICATIONS

This application claims the benefit of provisional patent application with application No. 61/331,393, filed on May 5, 2010 by the present inventors.

### FIELD OF THE INVENTION

The present invention relates to a computer method and system for recording words and their context as users browse documents.

### BACKGROUND OF THE INVENTION

One important aspect of foreign language learning is the acquisition of vocabulary. Usually, the body of vocabulary grows as the learner reads and comes across new words in the language. When a new word is encountered, at first, the learner needs to find the definition so she can continue reading the material at hand. Then she needs to memorize the new word if she were to use it in the future. The step of finding the definition is usually straightforward. Either a paper dictionary lookup, or, nowadays with the Internet, an online search, or a lookup using one of the many online dictionaries suffice. The step of memorization, however, has to happen in brute force. Like any other forms of brute force memorization, to aid the process, students of foreign languages commonly keep lists of new words so that they can review them regularly to reinforce the memory. Keeping track of the words can be aided by modern word processing or note-taking software, online or offline. But in general the student has to create and manage the list herself. In addition, the memorization process is often more effective when the contexts in which the new words occur are also available for review with the words themselves.

It is therefore the object of the present invention to provide an economical and convenient process and system to facilitate the accumulation of a new word list, together with the context of the words, as the users of the system come across them in reading materials.

### SUMMARY OF THE INVENTION

An embodiment of the present invention provides a method and system for storing words and their contexts to a database. This system and method is called Wordbees. The user first installs Wordbees Extraction Tool on her computer. When she comes across a new word as she browses the Internet, she selects the word and runs Wordbees Extraction Tool. The extraction tool detects the selected word and extracts the context of the word. In this embodiment the context comprises the sentences before and after the selected word and the URL of the web page the user currently viewing. The extraction tool further displays relevant information about the word. The extraction tool allows the user to store the word and its context in association a database. Wordbees also provides Wordbees Review Tool using which the user can review the list of words, and the associated contexts, she stored.

### BRIEF DESCRIPTION OF THE DRAWINGS

FIG. 1 is a flow diagram of Wordbees Extraction Tool.

FIG. 2 is a flow diagram of the process where the word and its context are stored remotely.

FIG. 3 is a flow diagram of Wordbees Review Tool.

FIG. 4 illustrates a user browsing session with a selected word and with the Wordbees Extraction Tool installed as a bookmarklet.

FIG. 5 illustrates the interface of Wordbees Extraction Tool.

FIG. 6 illustrates the interface of Wordbees Review Tool.

FIG. 7 illustrates the interface of Wordbees Review Tool in an embodiment where a list of stored words is sent via email to the user.

FIG. 8 is a block diagram that illustrates an embodiment of Wordbees in a client-server setting.

### DETAILED DESCRIPTION OF THE INVENTION

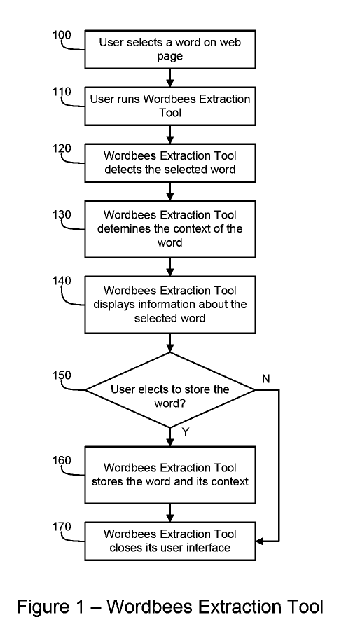

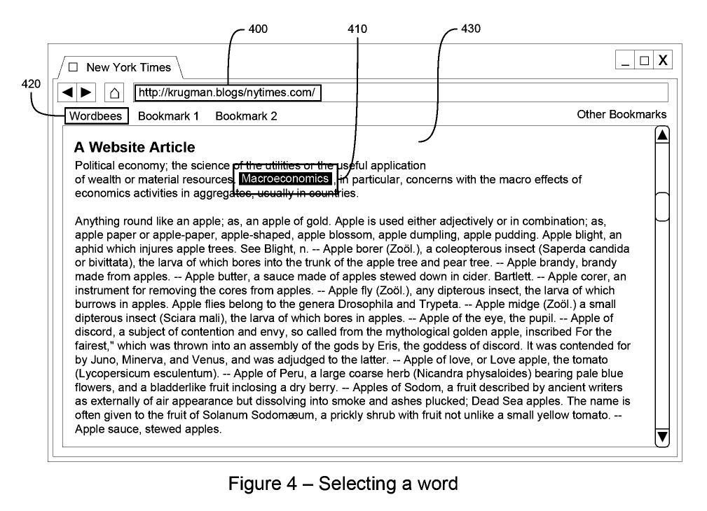

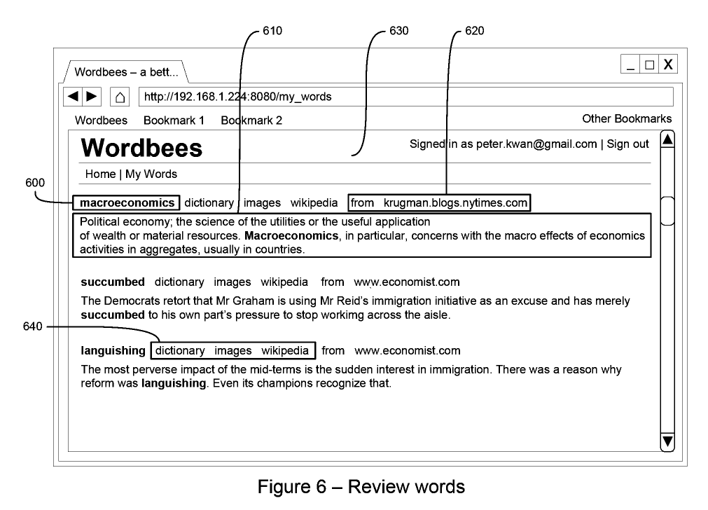

FIG. 1 depicts, for a preferred embodiment, the steps for storing a user-selected word from a document and the context in which it is found. The onscreen displays of this embodiment are depicted in FIGS. 4, 5, and 6. In this embodiment, the documents are web pages. Typical context information includes the few sentences before and after the selected word and the uniform resource locater (URL) of the web page. In step 100, the user selects word 410 in web page 430 that she is currently viewing. A typical selection is made by dragging the mouse pointer from the beginning of the word and releasing it at the end of the word. While selection 410 is in place, in step 110, the user runs Wordbees Extraction Tool. In a preferred embodiment, the extraction tool is a bookmarklet. A bookmarklet is a piece Javascript code that is presented as a bookmark link in the bookmark system of a web browser. Further, the bookmarklet is typically visible in the top of the browser interface in a graphical user interface (GUI) element usually known as the bookmark toolbar. The Javascript of the bookmarklet is executed when the user clicks on the link on the bookmark toolbar. In this embodiment, the user carries out step 110 by clicking on bookmarklet 420 while selection 410 is in place. Further, in this embodiment, the user installs the Wordbees bookmarklet prior to visiting web pages on which she likes to use Wordbees. Bookmarklet installation procedures differ between browsers from different vendors. But it typically involves visiting a web page on which the Javascript of the bookmarklet is present as a hypertext link. Dragging the link and dropping it in the bookmark toolbar will install the Javascript as a link on the bookmark system, and make it visible in the bookmark toolbar.

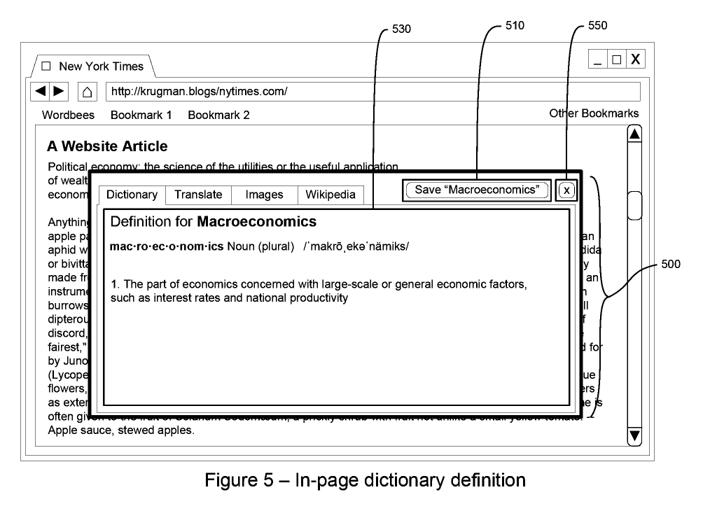

In step 120, the extraction tool detects selection 410 in web page 430. In step 130, the extraction tool determines the sentences before and after selection 410. In a preferred embodiment, steps 120 and 130 are carried out by executing the Javascript program of the bookmarklet. The Javascript uses standard browser Javascript API to retrieve the selected word and walk the Document Object Model (DOM) of the web page to retrieve the sentences before and after the selection. In step 140, the extraction tool displays relevant information about the selected word. Examples of relevant information include dictionary definition, translation, a lookup of the word in Wikipedia, and the results of an image search on the selected word. In a preferred embodiment, the extraction tool uses third-party web services to retrieve such information. In this embodiment, the extraction tool composes the URLs for those web services and display results from those web services inside an IFRAME 530 within a user interface 500 rendered by the extraction tool. In the embodiment using bookmarklet 420, the extraction tool overlays its interface 500 on top of web page 430. The Javascript program in bookmarklet 420 does so by injecting additional Javascript code into web page 430 to render interface 500. The relevant information depicted in FIG. 5 is a dictionary definition from Google. It is loaded by pointing IFRAME 530 to the URL http://www.google.com/dictionary?langpair=en|en&q=macroeconomic.

User interface 500 contains a visual element depicting an option whether or not to store the word. In a preferred embodiment, the visual element comprises button 510 and image of a cross 550. Clicking button 510 means the user elects to store the word. Clicking image of a cross 550 closes interface 500 without storing the word. Using Wordbees to only display relevant information of selection 410 without storing it is one of the desired use cases of Wordbees. In step 150, if the user clicks button 510, the word and its context are stored either locally or remotely in step 160. In another embodiment, the storing is automatic. This means the extraction tool, upon extracting the selected word and its context, always stores the word and its context without requiring the user to interact with any visual element. And therefore the interface in this embodiment does not contain a visual element depicting an option whether or not to store the word. Finally, the extraction tool closes interface 500 in step 170, returning the user to the original web page on which she selected the word. In another embodiment, the extraction tool does not automatically close interface 500. Instead, the user clicks the element 550 to explicitly close interface 500.

The Wordbees Extraction Tool, in another embodiment, is implemented as a browser extension. Examples of well-known browsers that support extension programming are the Mozilla Firefox, Google Chrome, Apple Safari, and Microsoft Internet Explorer. The extension implements the same process depicted in FIG. 1 using the extension programming environments of the respective browsers. In this embodiment, the running of the extraction tool may be automatic, in the sense that interface 500 appears immediately after user makes a word selection, without requiring any further user action apart from selecting the word. To do this, the browser extension continuously monitors for a non-empty selection in the web page and begins executing steps 130 and 140 without requiring the user to explicitly run the extraction tool.

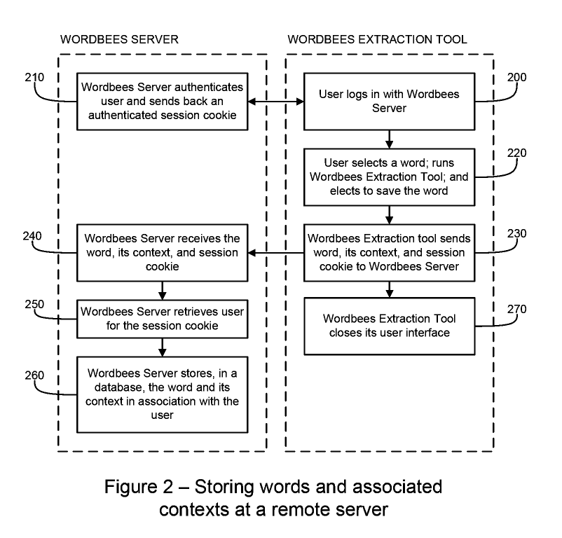

FIG. 2 illustrates a preferred embodiment for step 160, where the word and its context are stored remotely. The extraction tool sends, via web services, the word and its context to a remote server in step 230. Upon receiving the word and its context in an HTTP request in step 240, the remote server stores the word and its context in a database. In a preferred embodiment, in order to serve multiple users, the remote server uses a user management system typical for a web application. In such embodiment, the user first establishes a login session with the user management system prior to running the extraction tool in steps 200 and 210. When the extraction tool sends the word and its context to the server, it also sends the login session cookie along. The server then uses this cookie to determine whether the user has logged in and to look up the user in step 250. In step 260, the server associates the word and its context with the user, and stores all such information in database. Alternatively, if the user has not established a login session prior to electing to store the word, the user is presented with an interface for login after she elects to store the word, and before the word and its context are sent to the server. Finally, the extraction tool closes its superimposed interface 500 in step 270, returning the user to the original web page on which she selected the word.

In another embodiment, the word and its context are stored locally in a database, such as the Web Storage provided by the browser. Web Storage is a standard drafted by the World Wide Web Consortium (W3C), typically accessed in web browsers using the Javascript window.localStorage interface. The definition of the Web Storage standard can be accessed at http://dev.w3.org/html5/webstorage. In this embodiment, the extraction tool executes client-side Javascript function that stores the word and its context in the local persistent store. There is no user management and Wordbees Server in this embodiment.

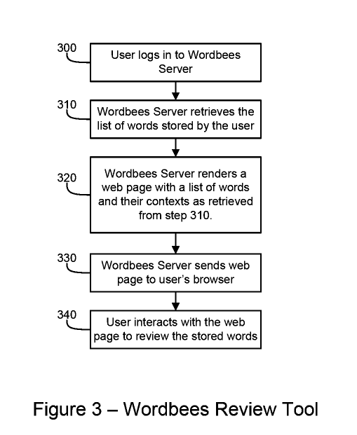

When one or more words and their contexts have been stored, the user may review the words using Wordbees Review Tool. In a preferred embodiment, the review tool is a web application that includes a series of web pages served by the Wordbees Server. The operation of the review tool is illustrated in FIG. 3. The user first logs in to the web application in step 300. Wordbees Server retrieves the list of words and their contexts stored by this user in step 310. With the retrieved words and contexts, the server renders web page 630 in step 320 and sends the page to user's browser in step 330. User interacts with web page 630 to review previously stored words in step 340. For each word, the web page displays the word 600 and its context, which in this embodiment comprises the few sentences 610 before and after the word and the URL 620 of the original web page when the word was selected. Optionally, the review tool provides an interface for conveniently retrieving relevant information of the word. One example of such interface is a set of hypertext links 640 to dictionary, images search, and Wikipedia.

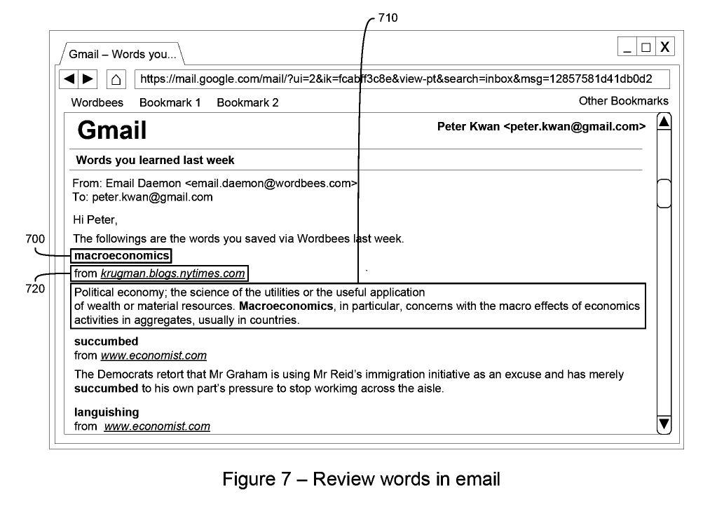

In another embodiment, the previously stored words and contexts are sent to the user in email at regular intervals, e.g. every week. One example of such email is depicted in FIG. 7. The email in FIG. 7 is sent by Wordbees Server to the user. The content of the email lists a number of words the user stored in the preceding week. Each entry shows the word 700 and its context, which in this embodiment comprises the few sentences 710 before and after the word and the URL 720 of the original web page when the word was selected.

In the embodiment where the words are stored in a local Web Storage database in step 160, Wordbees Review Tool is preferably implemented as a Javascript program running in a web browser. The program queries the local Web Storage database for stored words and contexts. Then renders them in an interface where the user interacts to review the words and their contexts.

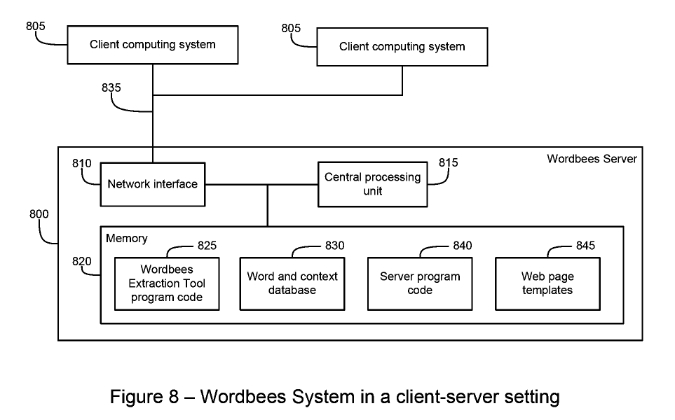

FIG. 8 is a block diagram that depicts all the various elements of a client-server embodiment of the present invention described thus far. Wordbees Server 800 is connected to client computing systems 805 in network 835, typically the Internet. Server 800 contains network interface 810 for connecting to network 835. It also contains central processing unit 815 which is in communication with memory 820 and network interface 810. Memory 820 stores Wordbees Extraction Tool program code 825. In one embodiment, Wordbees Extraction Tool program code 825 is packaged in a browser extension package file. Memory 820 also stores word and context database 830. Database 830 stores the words, associated contexts, and associated users that server 800 received, in step 240, from client computing systems 805. Memory 820 also stores server program code 840, which, when executed by central processing unit 815, carries out steps 210, 240, 250, 260, 300, 310, 320, and 330. Server program code 840 also contains logic that, when executed by central processing unit 815, facilitate the downloading and installation of Wordbees Extraction Tool program code 825 on client computing systems 805. In one embodiment server 800 displays a web page with a link for downloading Wordbees Extraction Tool program code 825. Upon clicking on the link, a user of client computing system 805 download Wordbees Extraction Tool program code 825 and install it for use on client computing system 805, typically in association with a web browser. In another embodiment, Wordbees Extraction Tool program code 825 is hosted at public repositories known as browser extension galleries. Examples of such galleries are located at:

https://addons.mozilla.org (Mozilla's Firefox Addons Gallery),
https://chrome.google.com/extensions (Google's Chrome Extension Gallery), and
http://extensions.apple.com (Apple's Safari Extensions Gallery).

Users of client computing systems 805 independently download and install Wordbees Extraction Tool program code 825 from those galleries before using the tool interactively with server 800.

Even though downloading the Wordbees Extraction Tool program code from a public gallery seems to be a separate action from other interactions with server 800. It should be consider as yet another embodiment for how program code is distributed, and accordingly it is considered equivalent in spirit to hosting the Wordbees Extraction Tool program code on server 800.

Memory 820 also stores web page templates 845. The templates define web pages that list stored words and their associated contexts. Those web pages are used in steps 320, 330, and 340. They are parts of the user interface of the Wordbees Review Tool.

Although the present invention has been described in terms of various embodiments and screenshots, it is not intended that the invention be limited to these embodiments. Modification within the spirit of the invention will be apparent to those skilled in the art. For example, in the embodiment where the words are stored remotely, instead of using a user management system to identify users, Internet Protocol (IP) addresses may be used to identify users. Another example is the selection in step 100 can be made over multiple words or characters. This is particularly relevant when using Wordbees to conveniently translate a section of a document, or when using Wordbees with character-based languages.

In a networked environment such as the Internet and the World Wide Web, the logic of the Wordbees Extraction Tool depicted FIGS. 1 and 2 may not be implemented as a single body of program code. It may be implemented by separate pieces of program code residing on separate computers that, when downloaded and executed in the same execution context of a web page, function as a whole to implement the functionality of the Wordbees Extraction Tool. In fact, depending on the scheme of program code organization chosen by the practitioner of the present invention, the multi-piece approach may be preferred. Indeed, the program listings attached in the appendix exemplifies such multi-piece approach. Listing 1000 contains the bookmarklet and it is the only piece of program code residing on client computing system 805. The code in listing 1000, when executed, downloads Wordbees_loader.js from a remote server, which in turns causes further Javascript code to be downloaded and executed in the execution context of the web page which the Wordbees user is viewing. This multi-piece organization may also be practiced when the Wordbees Extraction Tool is embodied by a browser extension. The browser extension may download further Javascript code from remote servers and execute them in the execution context of the web page viewed by the Wordbees user. Those separate pieces of Javascript code may work together with the code residing in the browser extension to implement the functionality of Wordbees Extraction Tool.

Various embodiments of the present invention may be practiced in a networked environment. The network may include a local area network (LAN), a cellular network, a wide area network (WAN), and the Internet, that are presented here as examples and not limitation. Those skilled in the art appreciate that such networked computing environments include many types of computer systems, including personal computers, hand-held devices, multi-processor systems, microprocessor-based or programmable consumer electronics, and the like. Accordingly, client computing systems 805 depicted in FIG. 8 may include, but are not limited to, desktop computers, laptop computers, TV set-top boxes, mobile phones, web pads, tablets, etc. Similarly, server 800 depicted in FIG. 8 may include multi-processor server systems, and mainframe computers. An exemplary implementation for server 800 might include a general purpose computing device in the form of a computer, including one or more processing units, a system memory, and a system bus that couples various system components including the system memory to the processing units. The system memory may include read only memory and random access memory. The computer may include a magnetic hard disk drive for reading from and writing to a magnetic hard disk, an optical disk drive for reading from or writing to a removable optical disk, and an interface for reading from and writing to solid state storage devices. The drives and the solid state storage devices and their associated machine readable media provide non-transitory, non-volatile storage of machine-executable instructions, data structures, program modules, and other data for the computer.

Further, components of server 800 depicted in FIG. 8 may be practiced in distributed computing environments where tasks are performed by more than one remote and local processing devices that are linked through a communications network. In a distributed computing environment, program modules may be located in both local and remote memory storage devices.

The computer program code described in the present invention includes machine instructions for a programmable processor, and can be implemented in a high-level programming language (e.g. Javascript, Python, etc), and/or in assembly and machine language. The terms “computer readable medium” and “machine readable medium” refer to any computer program product, apparatus and/or device, such as magnetic discs, optical disks, memory, and solid state drives, used to provide machine instructions and/or data to a programmable processor, including a machine readable medium that receives machine instructions as a machine readable signal. The term “machine readable signal” refers to any signal used to provide machine instructions and/or data to a programmable processor.

Although the presentation invention is described in details using embodiments, other modifications are possible. In addition, the logic flows depicted in FIGS. 1, 2, and 3 do not require the particular order shown, or be executed sequentially, to achieve the desired results. Other steps may be added to, or removed from, the described flows. Other components may be added to, or removed from, the described systems. Accordingly, all such variations are within the scope of the present invention and the following claims.

### APPENDIX TO THE SPECIFICATION

### Appendix 1

### Reference to Computer Program Listings

A set of computer program listings is submitted with this specification via the Electronic Filing System (EFS-Web) as text files. The full implementation of one embodiment of the present invention contains many more computer programs in many other files. Not all of them are listed. The set of programs chosen for inclusion in this disclosure pertains to the programs that demonstrate one implementation of the key inventive steps of the present invention.

Listing 1000: Filename is 1000_bookmarklet-js.txt, size is 581 bytes, created on May 3, 2010. The Javascript program in this file is executed when user clicks bookmarklet 420. This Javascript program causes the program in listing 1010 to be loaded and executed in the execution context of the web page on which the user has selected the word desired to be stored by Wordbees.

Listing 1010: Filename is 1010_wordbees_loader-js.txt, size is 1043 bytes, created on May 3, 2010. The Javascript program in this file is injected and executed by the Javascript program in listing 1000 into the web page on which the user selected the word. This Javascript program further causes the programs in listings 1020, 1030, and 1040 to be loaded and executed.

Listing 1020: Filename is 1020_wordbees_overlay-js.txt, size is 39534 bytes, created on May 3, 2010. This Javascript program contains the embodying implementation of steps 120, 130, and 140 of Wordbees Extraction Tool. This program detects the selected word; extracts the context of the selected word; and causes the user interface of Wordbees Extraction to be displayed superimposing the web page on which the user selected the word.

Listing 1030: Filename is 1030_wordbees_constants-js.txt, size is 2359 bytes, created on May 3, 2010. This Javascript program provides program constants for the program in listing 1020.

Listing 1040: Filename is 1040_wordbees_utils-js.txt, size is 4905 bytes, created on May 3, 2010. This Javascript program provides utility function for the program in listing 1020.

Listing 1050: Filename is 1050_wordbees_client-html.txt, size is 16576 bytes, created on May 3, 2010. This HTML web page is an embodiment of the user interface 500 of Wordbees Extraction Tool. In this interface 500, relevant information related to the selected word is displayed in step 140.

Listing 1060: Filename is 1060_wordbees_client-js.txt, size is 36883 bytes, created on May 3, 2010. This Javascript program works with the HTML web page in listing 1050 to embody the user interface 500 of Wordbees Extraction Tool.

Listing 1070: Filename is 1070_wordbees_preferences-js.txt, size is 7041 bytes, created on May 3, 2010. This Javascript program provides user preferences utility functions for the program in listing 1060.

Listing 1080: Filename is 1080_google_api-js.txt, size is 2778 bytes, created on May 3, 2010. This Javascript program provides program constants related to Google AJAX API used by the program in listing 1060.

Listing 1500: Filename is 1500_entry_views-py.txt, size is 1335 bytes, created on May 3, 2010. This Python program is a Django view. Function client_create implements steps 240, 250, and 260. Function list implements steps 310 and 320.

Listing 1510: Filename is 1510_list-html.txt, size is 929 bytes, created on May 3, 2010. This Django HTML template is an embodiment of the web page 630. This template in turn loads the template in listing 1520 to render each stored word and its context.

Listing 1520: Filename is 1520_entry_in_list-html.txt, size is 1910 bytes, created on May 3, 2010. This Django HTML template renders a stored word and its context, in support of web page 630.

Listing 1530: Filename is 1530_entry-py.txt, size is 5212 bytes, created on May 3, 2010. This file defines the model Entry. An Entry contains the selected word, the contexts, and a reference to the Wordbees user storing the word. It defines how an entry is represented in database 830. Class function create_entry implements step 260. Other functions assist in rendering web page fragments defined by listing 1520.

Listing 1540: Filename is 1540_wordbees_user-py.txt, size is 2365 bytes, created on May 3, 2010. This file defines the model WordbeesUser. It defines how a Wordbees user is represented in database 830. A reference to a WordbeesUser instance is kept in each Entry instance.

1. A computer-implemented method comprising:
detecting a selected word in a document being viewed in a graphical user interface at a client computing system;
extracting the context of the selected word in the viewed document;
displaying, in a graphic user interface of the client computing system wherein the word selection occurs, relevant information of the selected word;
storing the selected word and the extracted context in association in a database;
displaying, at a later time, in a graphical user interface of a client computing system, the stored word and the associated context by retrieving the stored word and the associated context from the database.

2. The method as defined in claim 1, wherein the extracted context comprises at least one member in the set:
at least one sentence around the selected word, and
the URL of the viewed document.

3. The method as defined in claim 1, wherein the relevant information comprises at least one member in the set:
a dictionary definition of the selected word,
a translation of the selected word, and
a result set from a search using the selected word as the search term.

4. The method as defined in claim 1, wherein the database is located on a server system remote to the client computing system wherein the word selection occurs.

5. The method as defined in claim 1, wherein the database is located locally on the client computing system wherein the word selection occurs.

6. The method as defined in claim 1, wherein the storing is subjected to an explicit choice by the user.

7. The method as defined in claim 1, wherein the displaying of the stored word occurs at a client computing system different from the client computing system wherein the word selection occurs.

8. The method as defined in claim 1, wherein the displaying of the stored word occurs at a client computing system that is the same as the client computing system wherein the word selection occurs.

9. A non-transitory computer readable medium associated with a computing system with a graphical user interface, comprising a computer readable program code embodied therein, the computer readable program code adapted to be executed to implement a method comprising:
detecting a selected word in a document being viewed in the graphical user interface of the computing system;
extracting the context of the selected word in the viewed document;
displaying, in the graphic user interface of the computing system, relevant information of the selected word;
storing the selected word and the extracted context in association in a local database;
displaying, at a later time, in the graphical user interface of the computing system, the stored word and the associated context by retrieving the stored word and the associated context from the local database.

10. The non-transitory computer readable medium as defined in claim 9, wherein the extracted context comprises at least one member in the set:
at least one sentence around the selected word, and
the URL of the viewed document.

11. The non-transitory computer readable medium as defined in claim 9, wherein the relevant information comprises at least one member in the set:
a dictionary definition of the selected word,
a translation of the selected word, and
a result set from a search using the selected word as the search term.

12. A non-transitory computer readable medium associated with a computing system with a graphical user interface, comprising a computer readable program code embodied therein, the computer readable program code adapted to be executed to implement a method comprising:
detecting a selected word in a document being viewed in the user interface of the computing system;
extracting the context of the selected word in the viewed document;
displaying, in a graphic user interface of the computing system, relevant information of the selected word;
sending the selected word and the extracted context to a server system, wherein the selected word and the extracted context are stored in association in a database.

13. The non-transitory computer readable medium as defined in claim 12, wherein the extracted context comprises at least one member in the set:
at least one sentence around the selected word, and
the URL of the viewed document.

14. The non-transitory computer readable medium as defined in claim 12, wherein the relevant information comprises at least one member in the set:
a dictionary definition of the selected word,
a translation of the selected word, and
a result set from a search using the selected word as the search term.

15. A computer-implemented server system comprising:
a memory that:
stores a database of words and the associated contexts of the words; and
stores a computer readable program code for execution on a client computing system with a graphical user interface, wherein the computer readable program code adapted to be executed to implement a method comprising:
detecting a selected word in a document being viewed in the graphical user interface of the client computing system;
extracting the context of the selected word in the viewed document;
displaying, in the graphic user interface of the client computing system, relevant information of the selected word; and
sending, from the client computing system, the selected word and the extracted context to the server system, wherein the selected word and the extracted context are stored in association in a database; and
a programmable processor in communication with the memory and network that
executes logic that facilitates the installation, on at least one client computing system, of the computer readable program code stored in the server memory;
executes logic that receives a selected word and the extracted context of the selected word from a client computing system; and stores the received word and the received context in association in a database.
executes logic, in response to a request from a client computing system, that retrieves at least one stored word and the associated context and sends the at least one stored word and the associated context to the client computing system, wherein the at least stored word and the associated context are displayed in a graphical user interface of the client computing system.

16. The server system as defined in claim 15, wherein the extracted context comprises at least one member in the set:
at least one sentence around the selected word, and
the URL of the viewed document.

17. The server system as defined in claim 15, wherein the relevant information comprises at least one member in the set:
a dictionary definition of the selected word,
a translation of the selected word, and
a result set from a search using the selected word as the search term.
